(19) United States
(12) Patent Application Publication
(10) Pub. No.: US 2019/0179578 A1
(43) Pub. Date: Jun. 13, 2019

(54) INFORMATION PROCESSING SYSTEM, INFORMATION TERMINAL, NON-TRANSITORY COMPUTER-READABLE STORAGE MEDIUM, AND CONTROL METHOD

(71) Applicant: SHARP KABUSHIKI KAISHA, Sakai City (JP)

(72) Inventor: HIDEKI SETO, Sakai City (JP)

(21) Appl. No.: 16/210,999

(22) Filed: Dec. 5, 2018

(30) Foreign Application Priority Data
Dec. 8, 2017 (JP) 2017-235662

(51) Int. Cl. G06F 3/12

(52) U.S. Cl. CPC G06F 3/128; G06F 3/1205; G06F 3/1287; G06F 3/1268; G06F 3/1206

(57) ABSTRACT

An information processing system includes a server, an image forming apparatus, and a user terminal. The user terminal includes a camera. The camera is activated when a direct printing application is executed. The user terminal transmits a photographed image photographed by the camera to a storage area for direct printing, which is in the server, via a public network. The image forming apparatus executes printing processing based on the photographed image in a case where the photographed image is stored in the storage area for direct printing.

### BACKGROUND

### 1. Field

The present disclosure relates to an information processing system, an information terminal, a non-transitory computer-readable storage medium, and a control method, and particularly relates to, for example, an image processing system capable of performing printing of an image, which is photographed by an information terminal, with an image forming apparatus, the information terminal used in the image processing system, a non-transitory computer-readable storage medium, and a control method.

### 2. Description of the Related Art

An example of such kind of related arts is disclosed in Japanese Unexamined Patent Application Publication No. 2004-328271. A data transmission control method of such a related art is a data transmission control method in a direct printing system including a digital camera and a printer. With the data transmission control method, setting of a communication mode is performed by receiving a user operation on a communication mode setting screen displayed on a display unit of the digital camera. Then, a wireless communication link is established between the digital camera and the printer in accordance with the setting of the communication mode. When the wireless communication link is established, an image photographed by the digital camera is immediately transmitted to the printer and printed by the printer.

However, in a case where the data transmission control method of the related art is applied to an information terminal connectable to a public line, when the wireless communication link is established, connection to the public line is disconnected in the information terminal, so that a function using the public line becomes unavailable. Thus, inconvenience appears.

In order to avoid such a problem, it is considered that an image is transmitted from the information terminal to the printer via the public line by applying the data transmission control method of the related art, but, since a large number of printers are connected to the public line, a printer that performs printing is selected from among the large number of printers, so that there is another problem that it takes time and effort.

Therefore, the disclosure provides an information processing system, an information terminal, a non-transitory computer-readable storage medium, and a control method that are new.

The disclosure also provides an information processing system, an information terminal, a non-transitory computer-readable storage medium, and a control method that allow, by a simple operation, an image forming apparatus to perform printing of an image photographed by the information terminal.

### SUMMARY

The disclosure provides an information processing system including an information terminal, a storage apparatus, and an image forming apparatus. The information terminal includes a first determination unit that determines whether or not the image forming apparatus exists within a predetermine distance, a photographing unit that is activated in a case where the first determination unit determines that the image forming apparatus exists within the predetermined distance and to execute photographing by a user operation, and a first transmission unit that transmits a photographed image photographed by the photographing unit to the storage apparatus via a public line. The storage apparatus stores the photographed image transmitted from the information terminal. The image forming apparatus includes an image forming unit that prints the photographed image stored in the storage apparatus.

The disclosure provides an information terminal that is used in an information processing system including an image forming apparatus which, when an image is stored in a storage apparatus, executes printing processing by using the image. The information terminal includes a first determination unit that determines whether or not the image forming apparatus exists within a predetermine distance, a photographing unit that is activated in a case where the first determination unit determines that the image forming apparatus exists within the predetermined distance and to execute photographing by a user operation, and a first transmission unit that transmits, as the image, a photographed image photographed by the photographing unit to the storage apparatus via a public line.

The disclosure provides a non-transitory computer-readable storage medium storing a control program of an information terminal that is used in an information processing system including an image forming apparatus which, when an image is stored in a storage apparatus, executes printing processing by using the image. The control program causes a processor of the information terminal to function as a first determination unit that determines whether or not the image forming apparatus exists within a predetermine distance, a photographing unit that is activated in a case where the first determination unit determines that the image forming apparatus exists within the predetermined distance and to execute photographing by a user operation, and a first transmission unit that transmits, as the image, a photographed image photographed by the photographing unit to the storage apparatus via a public line.

The disclosure provides a control method, executable by a processor of an information terminal that is used in an information processing system including an image forming apparatus which, when an image is stored in a storage apparatus, executes printing processing by using the image and that includes a photographing unit. The method includes (a) determining whether or not the image forming apparatus exists within a predetermined distance, (b) activating the photographing unit in a case where it is determined, at (a), that the image forming apparatus exists within the predetermined distance and executing photographing by a user operation, and (c) transmitting, as the image, a photographed image that is photographed at (b) to the storage apparatus via a public line.

Features and advantages of the disclosure will be further apparent from detailed description of embodiments below with reference to drawings.

### BRIEF DESCRIPTION OF THE DRAWINGS

FIG. 1 illustrates an example of a configuration of an information processing system of the disclosure;

FIG. 2 is a block diagram illustrating an electrical configuration of an image forming apparatus illustrated in FIG. 1;

FIG. 3 is a block diagram illustrating an electrical configuration of a user terminal illustrated in FIG. 1;

FIG. 4 is an explanatory diagram for explaining an example of an operation of the information processing system;

FIG. 5 is an explanatory diagram illustrating an example of a home screen of the user terminal;

FIG. 6 is an explanatory diagram illustrating an example of a photographing screen of the user terminal;

FIG. 7 is an explanatory diagram illustrating an example of a memory map of a RAM of the user terminal which is illustrated in FIG. 3;

FIG. 8 is an explanatory diagram illustrating an example of a memory map of a RAM of a server illustrated in FIG. 1;

FIG. 9 is an explanatory diagram illustrating an example of a memory map of a RAM of the image forming apparatus illustrated in FIG. 1;

FIG. 10 is a flowchart illustrating an example of information processing of a CPU of the user terminal which is illustrated in FIG. 3;

FIG. 11 is a flowchart illustrating an example of information processing of a CPU of the server illustrated in FIG. 1;

FIG. 12 is a flowchart illustrating an example of information processing of a CPU of the image forming apparatus which is illustrated in FIG. 2;

FIG. 13 is an explanatory diagram illustrating an example of a connection setting screen of a user terminal in a second embodiment;

FIG. 14 is a flowchart illustrating an example of information processing of a CPU of the user terminal in the second embodiment;

FIG. 15 is a flowchart illustrating an example of information processing of a CPU of the image forming apparatus in the second embodiment;

FIG. 16 is an explanatory diagram illustrating an example of a home screen of an image forming apparatus in a third embodiment;

FIG. 17 is an explanatory diagram illustrating an example of a code display screen of the image forming apparatus in the third embodiment;

FIG. 18 is an explanatory diagram illustrating an example of a code reading screen of a user terminal in the third embodiment;

FIG. 19 is a flowchart illustrating an example of information processing of a CPU of the image forming apparatus in the third embodiment; and

FIG. 20 is a flowchart illustrating an example of information processing of a CPU of the user terminal in the third embodiment.

### DESCRIPTION OF THE EMBODIMENTS

### First Embodiment

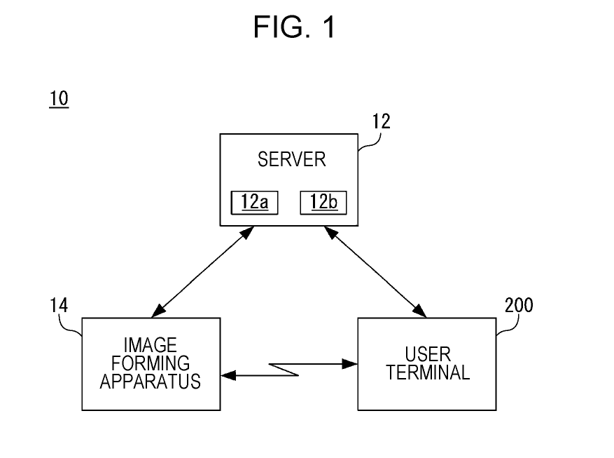

FIG. 1 illustrates an example of a configuration of an information processing system 10 of the disclosure. Referring to FIG. 1, the information processing system 10 of a first embodiment of the disclosure includes a server 12 and the server 12 is connected to an image forming apparatus 14 and an information terminal (user terminal) 200 so as to be able to perform communication via a public line (public network) such as the Internet.

Note that, one image forming apparatus 14 and one user terminal 200 are illustrated in FIG. 1, but two or more image forming apparatuses 14 and two or more user terminals 200 may be included.

The server 12 is a general-purpose server and includes components such as a CPU 12a, a RAM 12b, and a communication module. Moreover, the server 12 includes a storage unit configured by a non-volatile memory such as an HDD, an SSD, a flash memory, or an EEPROM.

In the first embodiment, the image forming apparatus 14 is a multifunction peripheral (MFP) that has a copying function, a printer function, a scanner function, a facsimile function, or the like. Note that, the disclosure is applicable not only to the multifunction peripheral but also to other image forming apparatuses such as a copying machine (copier), a printing apparatus (printer), and a facsimile. The disclosure is also applicable to a multimedia kiosk (MMK) terminal or the like that includes a print terminal for a photograph and a printer for a photograph.

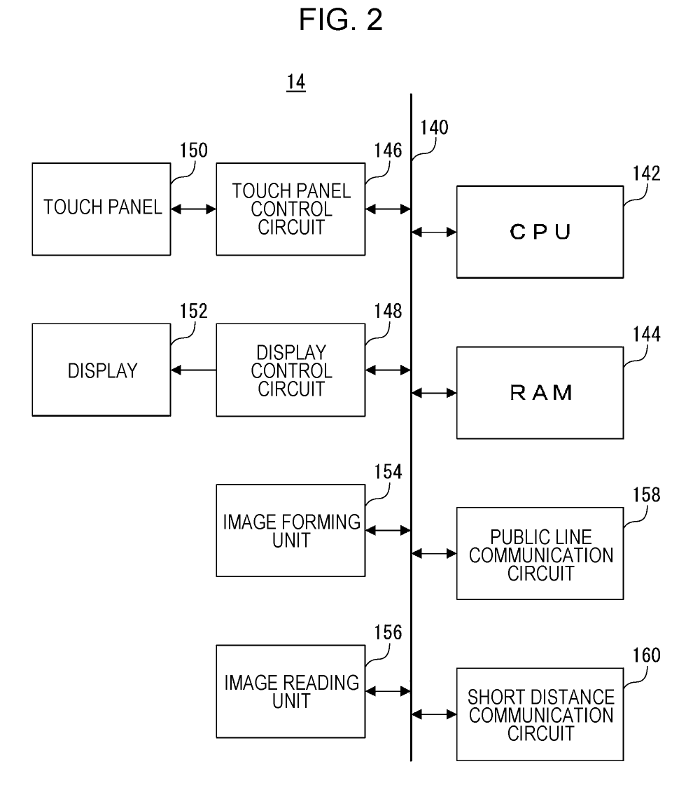

FIG. 2 is a block diagram illustrating an electrical configuration of the image forming apparatus 14 illustrated in FIG. 1. Referring to FIG. 2, the image forming apparatus 14 includes a CPU 142. The CPU 142 is connected with a RAM 144, a touch panel control circuit 146, a display control circuit 148, an image forming unit 154, an image reading unit 156, a public line communication circuit 158, and a short distance communication circuit 160 via a bus 140. The touch panel control circuit 146 is connected with a touch panel 150 and the display control circuit 148 is connected with a display 152. Examples of the display 152 include an LCD, an electroluminescence (EL) display, or the like, for example. The same is also applied to a display 212 of the user terminal 200 that is described later. In the first embodiment, as the touch panel 150, a touch panel of an electrostatic capacitive system is used and the touch panel 150 is provided on a display surface of the display 152. However, a touch panel display in which the touch panel 150 and the display 152 are integrally formed may be used. The touch panel 150 is not limited to one of the electrostatic capacitive system and one of any system such as an electromagnetic induction system, a resistance film system, or an infrared system may be used. The same is applied to a touch panel 210 of the user terminal 200 that is described later.

The CPU 142 controls the entire image forming apparatus 14. The RAM 144 is used as a work area and a buffer area of the CPU 142.

The touch panel control circuit 146 applies a voltage or the like to the touch panel 150 and, upon detection of a touch operation (touch input) within a touch effective range in the touch panel 150, outputs, to the CPU 142, touch coordinate data indicating a position of the detected touch input.

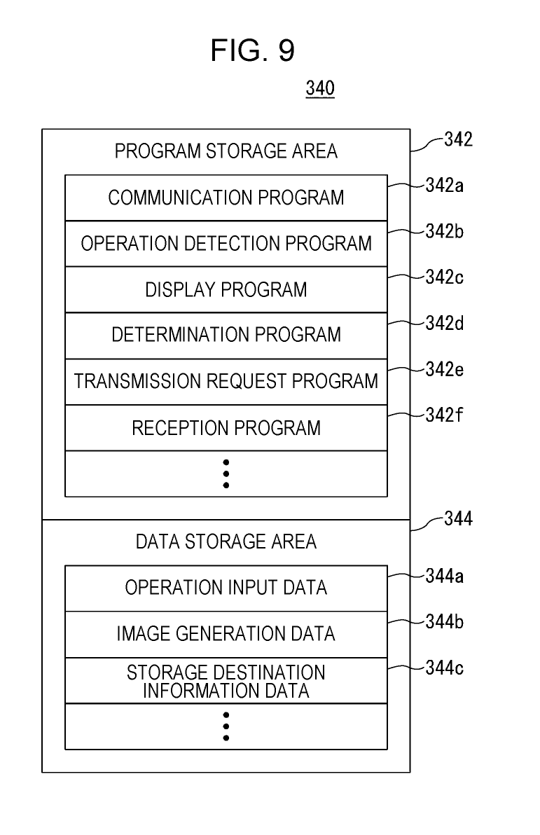

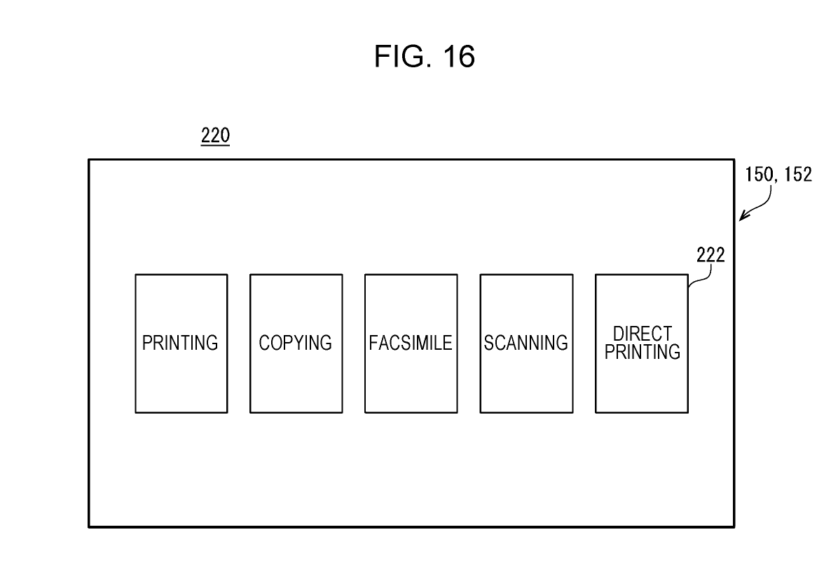

The display control circuit 148 includes a GPU, a VRAM, and the like. Under an instruction of the CPU 142, by using image generation data 344b (refer to FIG. 9) stored in the RAM 144, the GPU generates, in the VRAM, display image data for displaying various screens on the display 152 and outputs the generated display image data to the display 152. As an example, on the display 152, a screen such as a home screen 220 (refer to FIG. 16 or the like) that is an operation screen for selecting a desired job among various jobs which are able to be executed by the image forming apparatus 14 is displayed. In the first embodiment, a job means copying (including scanning of an original document), printing, transmission of a facsimile, or the like.

The image reading unit 156 includes a light source, a plurality of mirrors, an image forming lens, a line sensor, and the like. The image reading unit 156 exposes a surface of an original document with use of the light source and guides reflected light, which is reflected from the surface of the original document, to the image forming lens by the plurality of mirrors. Then, an image of the reflected light is formed on a light receiving element of the line sensor by the image forming lens. In the line sensor, luminance and chromaticity of the reflected light whose image is formed on the light receiving element are detected and read image data based on an image of the surface of the original document is generated.

The image forming unit (printing device) 154 is a general-purpose laser printer and includes a photoreceptor, a charger, an exposure device, a developing device, a transfer device, a fixing device, and the like to print, on a recording sheet (sheet) or the like, an image that corresponds to print data which is processed by an image processing circuit. However, the image forming unit 154 may be constituted by a sublimation printer or an inkjet printer instead of the laser printer.

The public line communication circuit 158 is a communication circuit for performing connection to a public network. The public line communication circuit 158 is a wired communication circuit or a wireless communication circuit, and performs communication with an external computer (external terminal) such as the server 12 or another information processing apparatus via a network such as the Internet based on a wired communication system conforming to a known communication standard such as Ethernet (registered trademark).

The short distance communication circuit 160 includes a wireless communication circuit. The wireless communication circuit performs direct communication with the user terminal 200 by short distance wireless communication based on a wireless communication system conforming to a known communication standard such as Bluetooth (registered trademark).

Note that, the electrical configuration of the image forming apparatus 14 illustrated in FIG. 2 is merely an example and there is no necessity to be limited thereto. For example, in the image forming apparatus 14, as a different input unit, an operation button of hardware such as an operation panel is provided or a keyboard of hardware is connected in some cases.

The user terminal 200 is a portable terminal that is able to be carried and examples thereof include a smartphone, a feature phone, and a tablet PC each of which is used for various purposes. The user terminal 200 includes various functions, for example, such as a speech communication function, an electronic mail function, and a browser function.

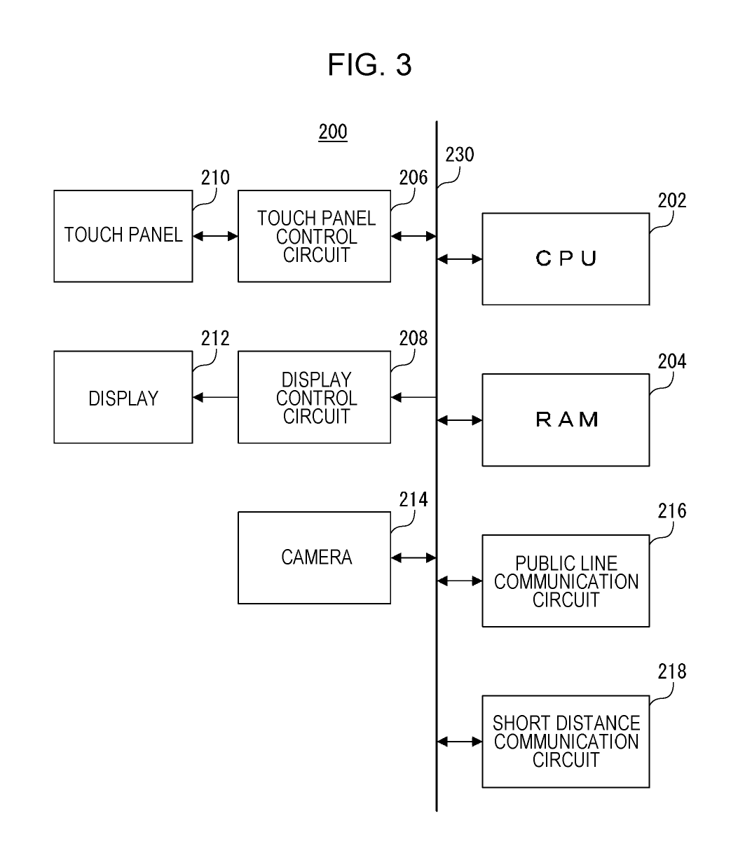

FIG. 3 is a block diagram illustrating an electrical configuration of the user terminal 200 illustrated in FIG. 1. Referring to FIG. 3, the user terminal 200 of the first embodiment includes a CPU 202. The CPU 202 is connected with a RAM 204, a touch panel control circuit 206, a display control circuit 208, a camera 214, a public line communication circuit 216, and a short distance communication circuit 218 via a bus 230. The touch panel control circuit 206 is connected with the touch panel 210 and the display control circuit 208 is connected with the display 212.

The CPU 202 controls the entire user terminal 200. The RAM 204 is used as a work area and a buffer area of the CPU 202.

The touch panel control circuit 206 applies a voltage or the like to the touch panel 210 and, upon detection of a touch input, outputs, to the CPU 202, touch coordinate data indicating a position of the touch input.

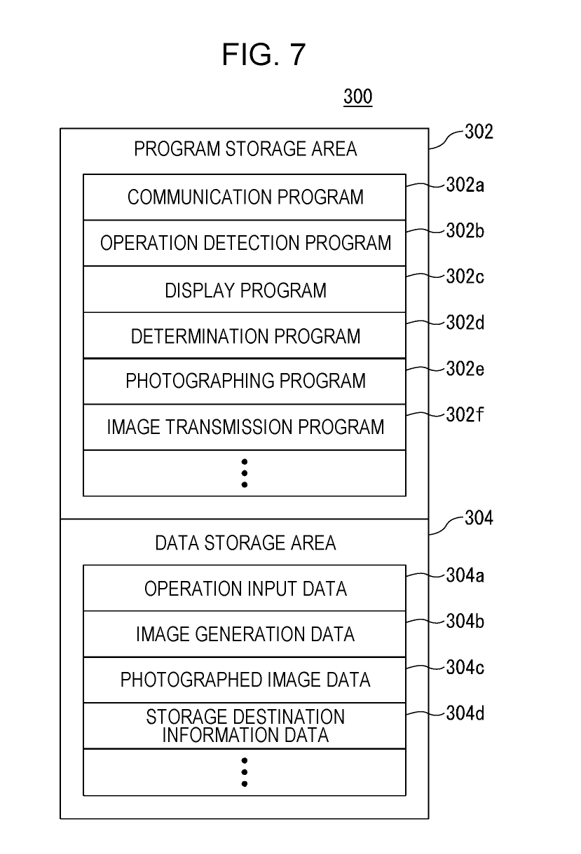

The display control circuit 208 includes a GPU, a VRAM, and the like. Under an instruction of the CPU 202, by using image generation data 304b (refer to FIG. 7) stored in the RAM 204, the GPU generates, in the VRAM, display image data for displaying various screens on the display 212 and outputs the generated display image data to the display 212.

The camera 214 has an image sensor and a focus lens whose position is able to be adjusted and captures an image by converting imaging light as visible light, which is taken from the image sensor, into an electrical signal. An example of the image sensor includes a solid state image sensor such as a charge coupled device (CCD) image sensor or a complementary metal oxide semiconductor (CMOS) image sensor. Photographed image data output from the camera 214 is stored in the RAM 204.

The public line communication circuit 216 is a communication circuit for performing connection to a public network and performs communication with an external computer such as the server 12 via the public network. Moreover, the user terminal 200 is connected to the public network via the public line communication circuit 216, so that Web browsing is able to be performed by the user terminal 200.

The short distance communication circuit 218 includes a wireless communication circuit and performs direct communication with the image forming apparatus 14 based on a wireless communication system conforming to a known communication standard such as Bluetooth.

Note that, the electrical configuration of the user terminal 200 illustrated in FIG. 3 is merely an example and there is no necessity to be limited thereto. For example, in the user terminal 200, as a different input unit, an operation button of hardware is provided in some cases. Furthermore, in FIG. 3, a component related to speech communication or the like is omitted for simplification.

In an information processing system in the related art, having such a configuration, a wireless communication link is established between a user terminal and an image forming apparatus, an image photographed by the user terminal is immediately transmitted to the image forming apparatus, and immediate printing (direct printing) in which printing is performed by the image forming apparatus is executed in some cases.

However, in the information processing system in the related art, in a case where the wireless communication link is established, connection to the public network is disconnected in the user terminal, so that a function (for example, an electronic mail function, a browser function, or the like) using the public network becomes unavailable. Thus, inconvenience appears.

In order to avoid such a problem, it is considered that an image is transmitted from a portable terminal to the image forming apparatus via the public network, but, since a large number of image forming apparatuses are connected to the public network, an image forming apparatus that performs printing is selected from among the large number of image forming apparatuses, so that there is a problem that it takes time.

Accordingly, in the information processing system 10 of the first embodiment, a photographed image photographed by the user terminal 200 is transmitted to a storage area for direct printing, which is in the server 12, via the public network. The image forming apparatus 14 is caused to access the server 12 and, when a photographed image is stored in the storage area for direct printing, is caused to execute printing processing based on the photographed image.

In the first embodiment, an application program (hereinafter, referred to as “direct printing application”) for performing direct printing, which operates in cooperation with a cloud service, is stored in the user terminal 200 and the image forming apparatus 14. Briefly, when the direct printing application is executed, a photographed image photographed by the user terminal 200 is transmitted to the server 12 via a public network, and printing processing is automatically executed by the image forming apparatus 14 based on the photographed image.

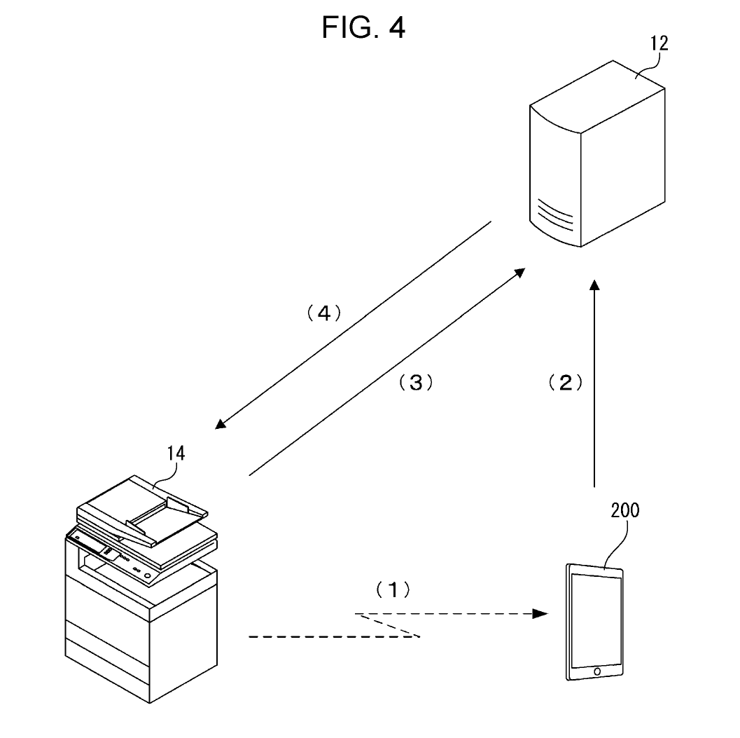

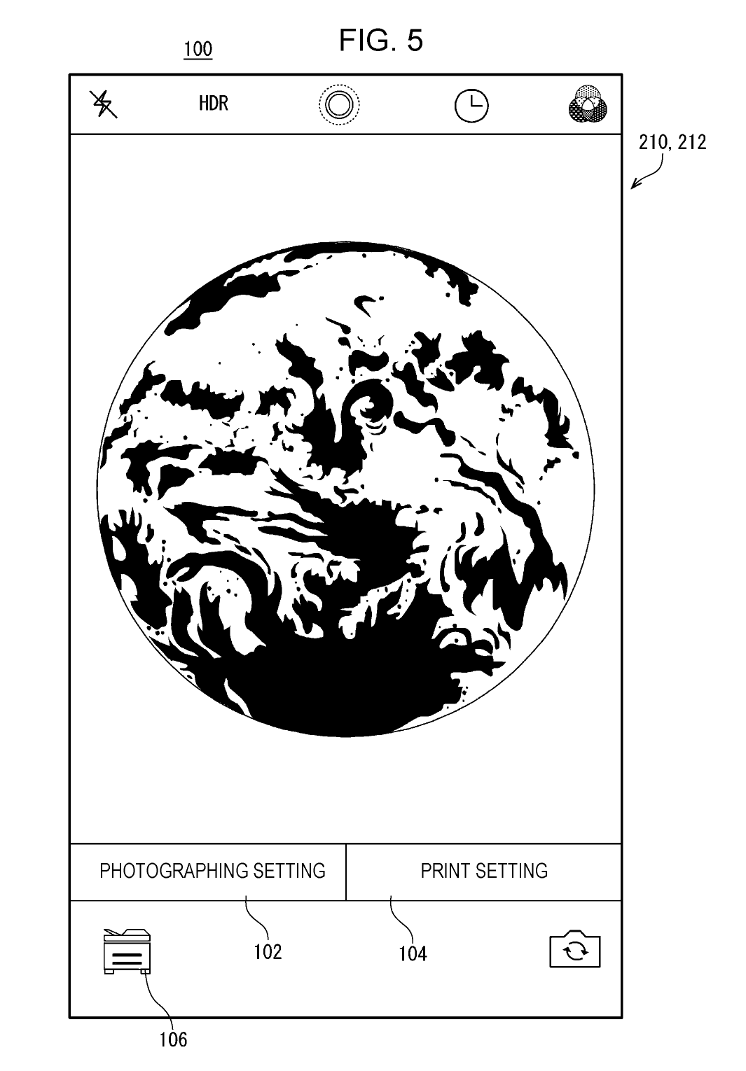

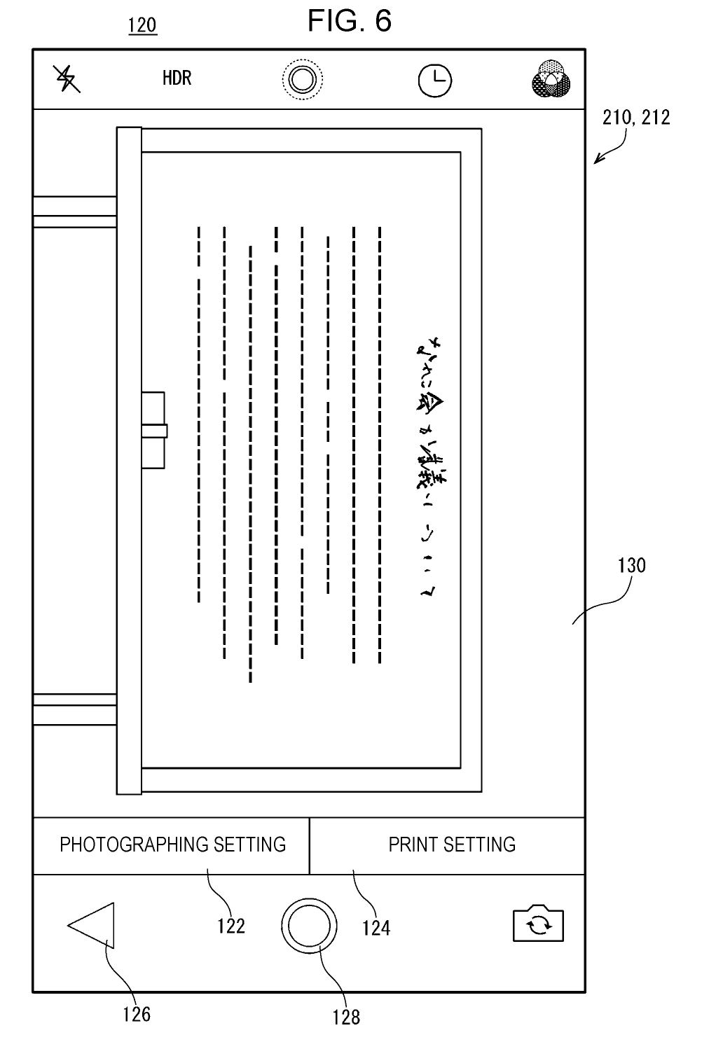

Hereinafter, an example of an operation of the information processing system 10 will be described with reference to FIG. 4 and the like. FIG. 4 is an explanatory diagram for explaining the example of the operation of the information processing system 10. FIG. 5 is an explanatory diagram illustrating an example of a home screen 100 of the user terminal 200. FIG. 6 is an explanatory diagram illustrating an example of a photographing screen 120 of the user terminal 200.

When the direct printing application is executed, the home screen 100 is displayed on the display 212 of the user terminal 200 as illustrated in FIG. 5. In the home screen 100, a standby image is displayed in the middle of the screen and images of a plurality of software keys (icons) allocated to various functions which are able to be executed by the direct printing application are also displayed. The plurality of icons include a photographing setting icon 102, a print setting icon 104, and an execution icon 106.

A function by which setting for photographing in the directing printing is performed by the user terminal 200 is allocated to the photographing setting icon 102. Though illustration is omitted, when the photographing setting icon 102 is touched (selected), a setting screen for performing setting for photographing is displayed on the display 212 and the setting for photographing is performed in accordance with a user operation. Examples of the setting for photographing include setting of an image size, brightness setting (i.e. exposure setting), and setting of a focus position. The same is also applied to photographing setting icons 122 and 262 that are described later.

A function by which print setting when a photographed image photographed by the user terminal 200 is printed is performed is allocated to the print setting icon 104. Though illustration is omitted, when the print setting icon 104 is touched, a setting screen for performing print setting is displayed on the display 212 and the print setting is performed in accordance with a user operation. Examples of the print setting include setting of a sheet size and setting of a color mode. The same is also applied to print setting icons 124 and 264 that are described later.

A function by which the camera 214 is activated to start photographing is allocated to the execution icon 106. However, the execution icon 106 is enabled when the image forming apparatus 14 exists within a predetermined distance from the user terminal 200, and the execution icon 106 is disabled when the image forming apparatus 14 does not exist within the predetermined distance from the user terminal 200. The execution icon 106 is able to be selected only when being enabled and is not able to be selected when being disabled. Though illustration is omitted, in a case where the execution icon 106 is disabled, the execution icon 106 is displayed in a gray-out (or translucent) state and an error message indicating that the execution icon 106 is not able to be touched or photographing is not able to be performed or the like is displayed.

Thus, as long as the image forming apparatus 14 exists within the predetermined distance from the user terminal 200, a user is able to touch the execution icon 106. However, whether or not the image forming apparatus 14 exists within the predetermined distance from the user terminal 200 is determined depending on whether or not the user terminal 200 is able to perform direct communication with the image forming apparatus 14 by short distance wireless communication. Note that, a state where the user terminal 200 is able to perform direct communication with the image forming apparatus 14 by short distance wireless communication means a state where wireless communication connection is not established and a radio wave transmitted from the short distance communication circuit 160 of the image forming apparatus 14 is able to be received by the short distance communication circuit 218 of the user terminal 200. For example, in a case where a communication available distance is approximately 10 m, when the image forming apparatus 14 exists within 10 m from the user terminal 200, it is determined that the image forming apparatus 14 exists within the predetermined distance from the user terminal 200.

In a case where, when the image forming apparatus 14 exists within the predetermined distance from the user terminal 200, the execution icon 106 is touched, the camera 214 is activated and the photographing screen 120 as illustrated in FIG. 6 is displayed on the display 212 of the user terminal 200 ((1) of FIG. 4).

On the photographing screen 120, a real-time moving image that corresponds to an image photographed by the camera 214, that is, a through image (preview image) and a plurality of icons are displayed. The plurality of icons include the photographing setting icon 122, the print setting icon 124, a back icon 126, and a shutter icon 128.

A function by which the photographing screen 120 is closed and display is returned to the home screen 100 is allocated to the back icon 126. When the back icon 126 is touched, the camera 214 is stopped and the home screen 100 is displayed on the display 212. The same is also applied to back icons 188 and 266 that are described later.

A function by which an image displayed on the display 212 is decided as an image to be output (corresponding to a photographed image) is allocated to the shutter icon 128. When the shutter icon 128 is touched, a photographed image is decided (photographed). Then, the user terminal 200 transmits the photographed image to the server 12 via a public network ((2) of FIG. 4).

When receiving the photographed image, the server 12 stores the photographed image in the storage unit of the server 12. However, a photographed image photographed by the direct printing application is stored in the storage area for direct printing, which is provided in the storage unit of the server 12.

The image forming apparatus 14 accesses the storage area for direct printing, which is in the server 12, and determines whether or not a photographed image exists (is stored) in the storage area for direct printing ((3) of FIG. 4). The processing is repeated at a predetermined cycle (for example, every 30 seconds to 60 seconds) (polling).

If a photographed image is stored in the storage area for direct printing, the image forming apparatus 14 acquires the photographed image. Specifically, the image forming apparatus 14 transmits a transmission request for the photographed image to the server 12. When receiving the transmission request, the server 12 transmits the photographed image to the image forming apparatus 14 (transmission request source) that has transmitted the transmission request ((4) of FIG. 4). At this time, whether or not data of the photographed image transmitted to the image forming apparatus 14 is deleted has been previously decided. In a case where the data of the photographed image transmitted to the image forming apparatus 14 is deleted, the server 12 deletes the data of the photographed image from the storage unit after transmitting the photographed image to the image forming apparatus 14.

When receiving the photographed image, the image forming apparatus 14 automatically executes printing processing based on the photographed image.

When the CPU 202 of the user terminal 200 executes an information processing program for the user terminal 200, which is stored in the RAM 204, the CPU 12a of the server 12 executes an information processing program for the server 12, which is stored in the RAM 12b, and the CPU 142 of the image forming apparatus 14 executes an information processing program for the image forming apparatus 14, which is stored in the RAM 144, an operation of the information processing system 10 as described above is realized. Specific processing will be described later by using a flowchart.

FIG. 7 is an explanatory diagram illustrating an example of a memory map 300 of the RAM 204 of the user terminal 200 which is illustrated in FIG. 3. As illustrated in FIG. 7, the RAM 204 includes a program storage area 302 and a data storage area 304. As described above, the information processing program for the user terminal 200 is stored in the program storage area 302 of the RAM 204. The information processing program for the user terminal 200 includes a communication program 302a, an operation detection program 302b, a display program 302c, a determination program 302d, a photographing program 302e, and an image transmission program 302f.

The communication program 302a is a program for performing communication (transmission/reception) of data with another computer or another device such as the server 12 via a public network. The communication program 302a is also a program for receiving a radio wave transmitted from the short distance communication circuit 160 of the image forming apparatus 14 by short distance wireless communication.

The operation detection program 302b is a program for detecting a touch input, and the CPU 202 acquires, in accordance with the operation detection program 302b, touch coordinate data output from the touch panel 210 and stores the acquired touch coordinate data in the RAM 204 in time series. However, as described above, when an operation button of hardware is provided, an input of the operation button is also detected in accordance with the operation detection program 302b.

The display program 302c is a program for generating display image data, that is, screen data such as the aforementioned home screen 100 or photographing screen 120 by using the image generation data 304b described later, and outputting the screen data to the display 212.

The determination program 302d is a program for determining whether or not an image forming apparatus exists within a predetermined distance (whether or not a radio wave transmitted from the short distance communication circuit 160 of the image forming apparatus 14 is received).

The photographing program 302e is a program for controlling the camera 214 and acquiring a photographed image. However, the photographing program 302e is executed in a case where it is determined that the image forming apparatus exists within the predetermined distance, and is not executed in a case where it is determined that the image forming apparatus does not exist within the predetermined distance.

The image transmission program 302f is a program for transmitting, to the server 12, photographed image data 304c that corresponds to the photographed image. Note that, the communication program 302a is executed at a transmitting time.

Though illustration is omitted, in the program storage area 302, a program for selecting and executing various functions included in the user terminal 200 and the like are also stored.

Additionally, in the data storage area 304 of the RAM 204, operation input data 304a, the image generation data 304b, the photographed image data 304c, storage destination information data 304d, and the like are stored.

The operation input data 304a is data in which the touch coordinate data that is detected in accordance with the operation detection program 302b is stored in time series. Note that, in the operation input data 304a, operation data about a button of hardware is included in some cases.

The image generation data 304b is data, such as polygon data or texture data, for generating display image data corresponding to various screens to be displayed on the display 212.

The photographed image data 304c is image data for the photographed image that is photographed by the camera 214 in accordance with the photographing program 302e.

The storage destination information data 304d is data indicating a storage destination of the photographed image data 304c in the server 12. Specifically, the storage destination information data 304d is data about a first storage area 324a that is used as the storage area for direct printing.

Note that, though illustration is omitted, in the data storage area 304, photographing setting data about setting related to photographing, print setting data about print setting when the photographed image is printed, and different data for executing the information processing program for the user terminal 200 may be stored and a timer (counter) or a register for executing the information processing program for the user terminal 200 may be provided.

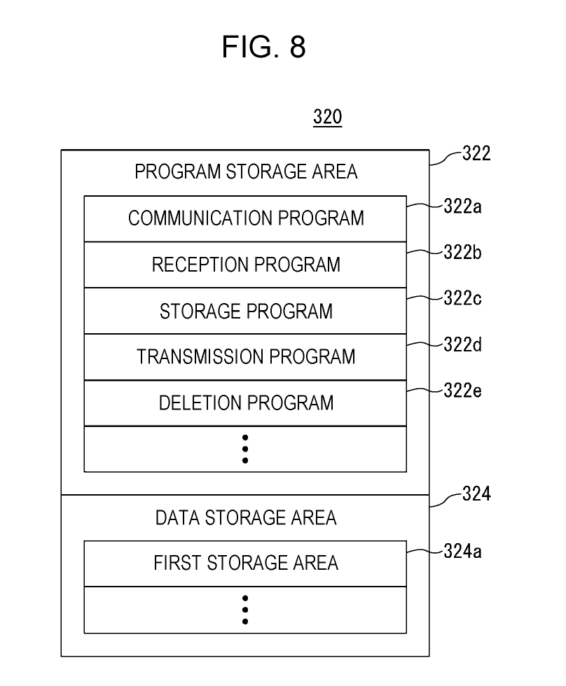

FIG. 8 is an explanatory diagram illustrating an example of a memory map 320 of the RAM 12b of the server 12 illustrated in FIG. 1. As illustrated in FIG. 8, the RAM 12b includes a program storage area 322 and a data storage area 324. As described above, the information processing program for the server 12 is stored in the program storage area 322 of the RAM 12b. The information processing program for the server 12 includes a communication program 322a, a reception program 322b, a storage program 322c, a transmission program 322d, and a deletion program 322e.

The communication program 322a is a program for performing communication with another computer or another device such as the user terminal 200 and the image forming apparatus 14 via a public network.

The reception program 322b is a program for receiving the photographed image data transmitted from the user terminal 200. Note that, the communication program 322a is executed at a receiving time.

The storage program 322c is a program for storing the photographed image data, which is received in accordance with the reception program 322b, in the storage area (first storage area 324a) for direct printing.

The transmission program 322d is a program for transmitting, to the image forming apparatus 14, the photographed image stored in the first storage area 324a. Note that, the communication program 322a is executed at a transmitting time.

The deletion program 322e is a program for deleting the photographed image data from the first storage area 324a in a case where the photographed image data is transmitted to the image forming apparatus 14.

Note that, though illustration is omitted, in the program storage area 322, a program for selecting and executing various functions included in the server 12 and the like are also stored.

Additionally, in the data storage area 324 of the RAM 12b, the first storage area 324a is included. The first storage area 324a is used as the storage area for direct printing and stores the photographed image data that is received in accordance with the reception program 322b.

Note that, though illustration is omitted, in the data storage area 324, different data for executing the information processing program for the server 12 may be stored and a timer (counter) or a register for executing the information processing program for the server 12 may be provided.

FIG. 9 is an explanatory diagram illustrating an example of a memory map 340 of the RAM 144 of the image forming apparatus 14 illustrated in FIG. 2. As illustrated in FIG. 9, the RAM 144 includes a program storage area 342 and a data storage area 344. As described above, the information processing program for the image forming apparatus 14 is stored in the program storage area 342 of the RAM 144. The information processing program for the image forming apparatus 14 includes a communication program 342a, an operation detection program 342b, a display program 342c, a determination program 342d, a transmission request program 342e, and a reception program 342f.

The communication program 342a is a program for performing communication with another computer or another device such as the server 12 via a public network.

The operation detection program 342b is a program for detecting a touch input, and the CPU 142 stores touch coordinate data, which is acquired in accordance with the operation detection program 342b, in the RAM 144 in time series. However, as described above, in a case where a button of hardware is provided or a keyboard of hardware is connected, an input of the button or a key is also detected in accordance with the operation detection program 342b.

The display program 342c is a program for generating display image data, that is, screen data such as an operation screen by using the image generation data 344b described later, and outputting the screen data to the display 152.

The determination program 342d is a program for accessing the first storage area 324a of the server 12 at a predetermined cycle and determining whether or not a photographed image is stored. Note that, the communication program 342a is executed at a time of accessing the first storage area 324a of the server 12. Additionally, an access destination is decided in accordance with storage destination information data 344c.

The transmission request program 342e is a program for, in a case where it is determined that a photographed image is stored in the first storage area 324a, specifying the photographed image and transmitting a transmission request signal of the photographed image to the server 12. Note that, the communication program 342a is executed at a time of transmitting the transmission request signal.

The reception program 342f is a program also for receiving image data of the photographed image transmitted from the server 12. Note that, the communication program 342a is executed at a receiving time.

Note that, though illustration is omitted, in the program storage area 342, an image reading program, an image forming program, and the like are also stored. The image reading program is a program for controlling the image reading unit 156 to read an image of an original document and to output an image signal (image data) that corresponds to the read image. The image forming program is a program for controlling the image forming unit 154 to print a full-color or monochromatic image on a sheet. Moreover, in the program storage area 342, a program for selecting and executing various functions included in the image forming apparatus 14 and the like are also stored.

Additionally, in the data storage area 344 of the RAM 144, operation input data 344a, the image generation data 344b, the storage destination information data 344c, and the like are stored.

The operation input data 344a is data in which the touch coordinate data that is detected in accordance with the operation detection program 342b is stored in time series. Note that, in the operation input data 344a, operation data about a button or a key of hardware is included in some cases.

The image generation data 344b is data, such as polygon data or texture data, for generating display image data corresponding to various screens to be displayed on the display 152.

The storage destination information data 344c is data indicating a storage destination (the first storage area 324a) of the photographed image data in the server 12.

Note that, though illustration is omitted, in the data storage area 344, different data for executing the information processing program for the image forming apparatus 14 may be stored and a timer (counter) or a register for executing the information processing program for the image forming apparatus 14 may be provided.

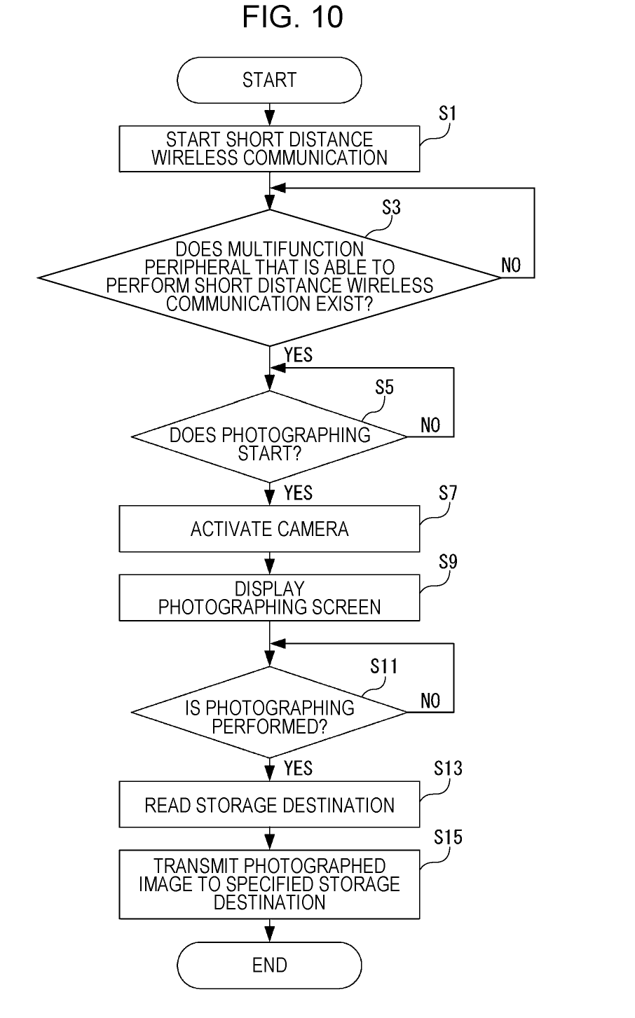

FIG. 10 is a flowchart illustrating an example of information processing of the CPU 202 of the user terminal 200 illustrated in FIG. 3. The information processing is started when the direct printing application is executed. Note that, the home screen 100 is displayed on the display 212 in a case where the information processing is started.

As illustrated in FIG. 10, when starting the information processing, the CPU 202 of the user terminal 200 starts short distance wireless communication at step S1 and determines, at step S3, whether or not a multifunction peripheral (image forming apparatus) that is able to perform short distance wireless communication exists. Here, it is determined whether or not the user terminal 200 is able to perform direct communication with the image forming apparatus 14 by the short distance wireless communication.

In a case of “NO” at step S3, that is, in a case where no multifunction peripheral that is able to perform short distance wireless communication exists, the procedure returns to the same step S3.

On the other hand, in a case of “YES” at step S3, that is, in a case where a multifunction peripheral that is able to perform short distance wireless communication exists, whether or not photographing is started is determined at step S5. Here, it is determined whether or not the execution icon 106 is touched on the home screen 100. In a case of “NO” at step S5, that is, in a case where the photographing is not started, the procedure returns to the same step S5.

On the other hand, in a case of “YES” at step S5, that is, in a case where the photographing is started, the camera 214 is activated at step S7, the photographing screen 120 is displayed on the display 212 at step S9, and whether or not the photographing is performed is determined at step S11. Here, it is determined whether or not the shutter icon 128 is touched on the photographing screen 120.

In a case of “NO” at step S11, that is, in a case where a photographed image is not decided, the procedure returns to the same step S11. On the other hand, in a case of “YES” at step S11, that is, in a case where the photographed image is decided, a storage destination of the photographed image is read at step S13, the photographed image is transmitted to the specified storage destination (server 12) at step S15, and the information processing ends.

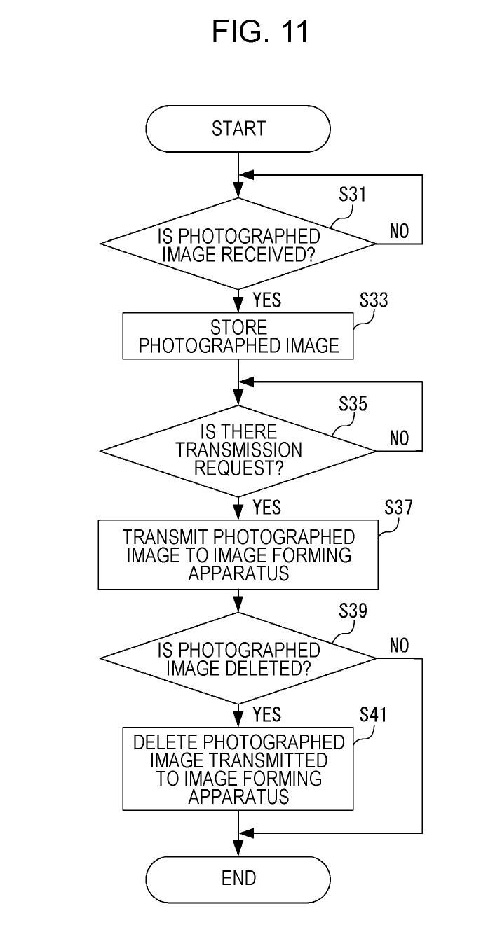

Next, information processing that is executed by the CPU 12a of the server 12 will be described. FIG. 11 is a flowchart illustrating an example of the information processing of the CPU 12a of the server 12 illustrated in FIG. 1.

As illustrated in FIG. 11, when starting the information processing, the CPU 12a of the server 12 determines, at step S31, whether or not the photographed image transmitted from the user terminal 200 is received. In a case of “NO” at step S31, that is, in a case where the photographed image is not received, the procedure returns to the same step S31. On the other hand, in a case of “YES” at step S31, that is, in a case where the photographed image is received, the photographed image is stored in the storage area for direct printing, which is in the server 12, at step S33, and whether or not there is a transmission request for the photographed image is determined at step S35.

In a case of “NO” at step S35, that is, in a case where there is no transmission request for the photographed image, the procedure returns to the same step S35. On the other hand, in a case of “YES” at step S35, that is, in a case where there is a transmission request for the photographed image, the photographed image is transmitted to the image forming apparatus 14 that is a transmission request source at step S37, and whether or not the photographed image transmitted to the image forming apparatus 14 at step S37 is deleted is determined at step S39.

In a case of “NO” at step S39, that is, in a case where it is determined that the photographed image is not deleted, the photographed image is not deleted and the information processing ends. On the other hand, in a case of “YES” at step S39, that is, in a case where it is determined that the photographed image is deleted, the photographed image transmitted to the image forming apparatus 14 at step S37 is deleted at step S41 and the information processing ends.

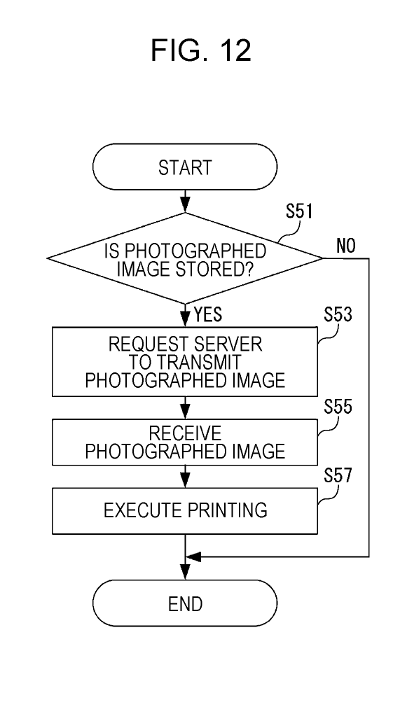

Next, information processing that is executed by the CPU 142 of the image forming apparatus 14 will be described. FIG. 12 is a flowchart illustrating an example of the information processing that is executed by the CPU 142 of the image forming apparatus 14 illustrated in FIG. 2.

As illustrated in FIG. 12, when starting the information processing, at step S51, the CPU 142 of the image forming apparatus 14 accesses the storage area for direct printing, which is in the server 12, to determine whether or not the photographed image is stored. In a case of “NO” at step S51, that is, in a case where it is determined that the photographed image is not stored, the information processing ends.

On the other hand, in a case of “YES” at step S51, that is, in a case where it is determined that the photographed image is stored, a transmission request for the photographed image is transmitted to the server 12 at step S53, the photographed image is received at step S55, printing processing is automatically executed based on the photographed image at step S57, and the information processing ends.

However, the information processing executed by the CPU 142 of the image forming apparatus 14 is repeatedly executed at a predetermined cycle.

In the first embodiment, the user terminal 200 transmits a photographed image photographed by the camera 214 to the storage area for direct printing, which is in the server 12, via a public network. Additionally, in a case where a photographed image is stored in the storage area for direct printing, which is in the server 12, the image forming apparatus 14 executes printing processing based on the photographed image. Thus, a user only executes the direct printing application and touches the shutter icon 128, so that it is possible to print the photographed image, which is photographed by the user terminal 200, by the image forming apparatus 14 with a simple operation.

### Second Embodiment

Since the information processing system 10 of a second embodiment is the same as that of the first embodiment except that a plurality of image forming apparatuses 14 are included, the storage area for direct printing, which is in the server 12, includes a plurality of storage areas, each of the plurality of storage areas is allocated to a corresponding one of the image forming apparatuses 14 adaptable to the direct printing application, and storage destination information about the storage area for the corresponding image forming apparatus 14 is transmitted from the image forming apparatus 14 to the user terminal 200, a content different from that of the first embodiment will be described and duplicate description will be omitted.

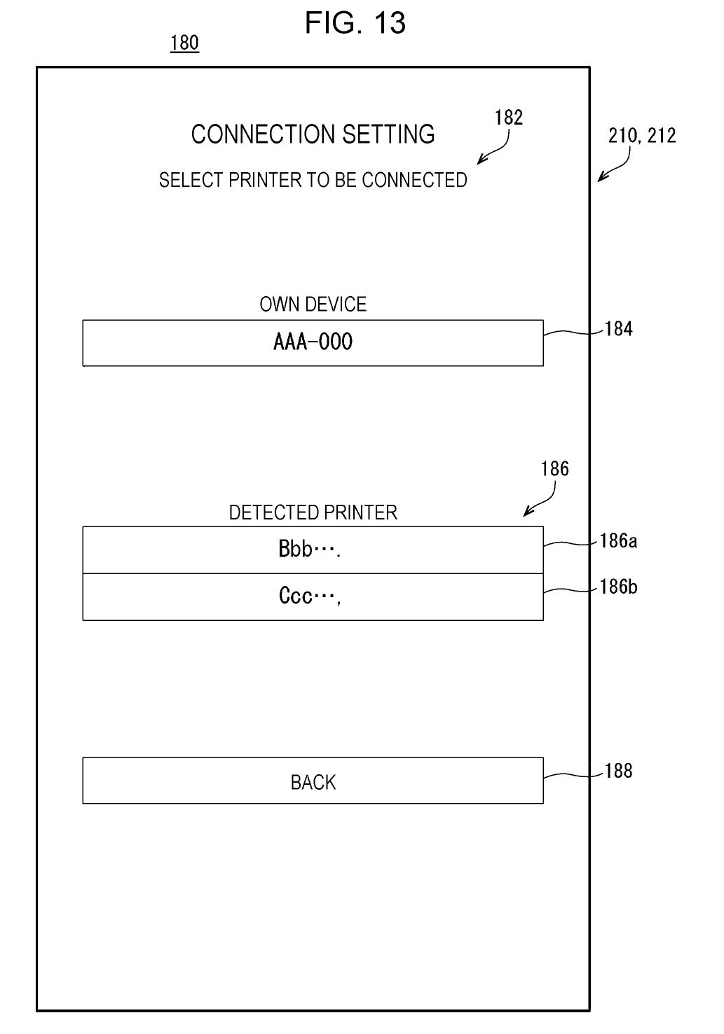

FIG. 13 is an explanatory diagram illustrating an example of a connection setting screen of the user terminal 200 of the second embodiment. When the direct printing application is executed, a connection setting screen 180 is displayed on the display 212 of the user terminal 200. The connection setting screen 180 is a screen for selecting an image forming apparatus 14 which is to print a photographed image. On the connection setting screen 180, a message 182 for urging a user to select an image forming apparatus 14 to be connected, an information icon 184 indicating information of the user terminal 200, a selection icon 186 for selecting the image forming apparatus 14 to be connected, and the back icon 188 are displayed.

The selection icon 186 corresponds to an image forming apparatus 14 that is able to perform direct communication by short distance wireless communication. Additionally, as illustrated in FIG. 13, in a case where there are a plurality of image forming apparatuses 14 that are able to perform direct communication by short distance wireless communication, a plurality of selection icons 186 each of which corresponds to a corresponding one of the plurality of image forming apparatuses 14 are displayed on the connection setting screen 180. For example, a selection icon 186a that corresponds to a first image forming apparatus 14 and a selection icon 186b that corresponds to a second image forming apparatus 14 are displayed on the connection setting screen 180. However, the image forming apparatuses 14 that correspond to the selection icons 186 are image forming apparatuses 14 adaptable to the direct printing application.

When the selection icon 186 is touched, short distance wireless connection is established between the user terminal 200 and an image forming apparatus 14 which corresponds to the touched selection icon 186. However, various kinds of authentication processing to establish the short distance wireless connection are automatically executed. For example, when the selection icon 186 is touched, the user terminal 200 automatically acquires authentication information of the image forming apparatus 14 to execute authentication processing. In this case, the authentication information of the image forming apparatus 14 adaptable to the direct printing application may be stored in a database of the direct printing application, which is able to be accessed by the user terminal 200, or the authentication information of the image forming apparatus 14 adaptable to the direct printing application may be stored in a storage unit of the user terminal 200 in advance.

When the short distance wireless connection is established between the user terminal 200 and the image forming apparatus 14, storage destination information about a storage area for the image forming apparatus 14 is transmitted from the image forming apparatus 14 to the user terminal 200.

Additionally, when the short distance wireless connection is established between the user terminal 200 and the image forming apparatus 14, the home screen 100 is displayed on the display 212 of the user terminal 200. At this time, since the short distance wireless connection is established between the user terminal 200 and the image forming apparatus 14, the execution icon 106 is enabled. The user terminal 200 receives the storage destination information transmitted from the image forming apparatus 14.

Then, when the execution icon 106 is touched on the home screen 100, the camera 214 is activated and the photographing screen 120 is displayed. When the shutter icon 128 is touched on the photographing screen 120, the user terminal 200 transmits a photographed image to the server 12 via a public network in accordance with the storage destination information. Note that, the storage destination information (information about the storage area for the image forming apparatus 14) is associated with data of the photographed image transmitted from the user terminal 200 to the server 12.

When receiving the photographed image and the storage destination information, the server 12 stores the photographed image in the storage unit (storage area for the image forming apparatus 14) of the server 12 in accordance with the storage destination information associated with the photographed image.

The image forming apparatus 14 accesses the storage area for the image forming apparatus 14 at a predetermined cycle, and, when a photographed image is stored in the storage area for the image forming apparatus 14, automatically executes printing processing based on the photographed image.

In the second embodiment, in order to realize the operation described above, an authentication program for performing various kinds of authentication processing to establish the short distance wireless connection, and the like are included in the information processing program for the user terminal 200, which is stored in the RAM 204 of the user terminal 200. Additionally, in the information processing program for the image forming apparatuses 14, which is stored in the RAM 144 of the image forming apparatuses 14, a transmission program for transmitting the storage destination information about the storage area for the image forming apparatus 14 to the user terminal 200 and the like are included.

Hereinafter, information processing in the second embodiment will be described with reference to flowcharts, the same reference sign is assigned to processing that is the same as the information processing described in the first embodiment, and description of a duplicated content will be omitted or briefly given.

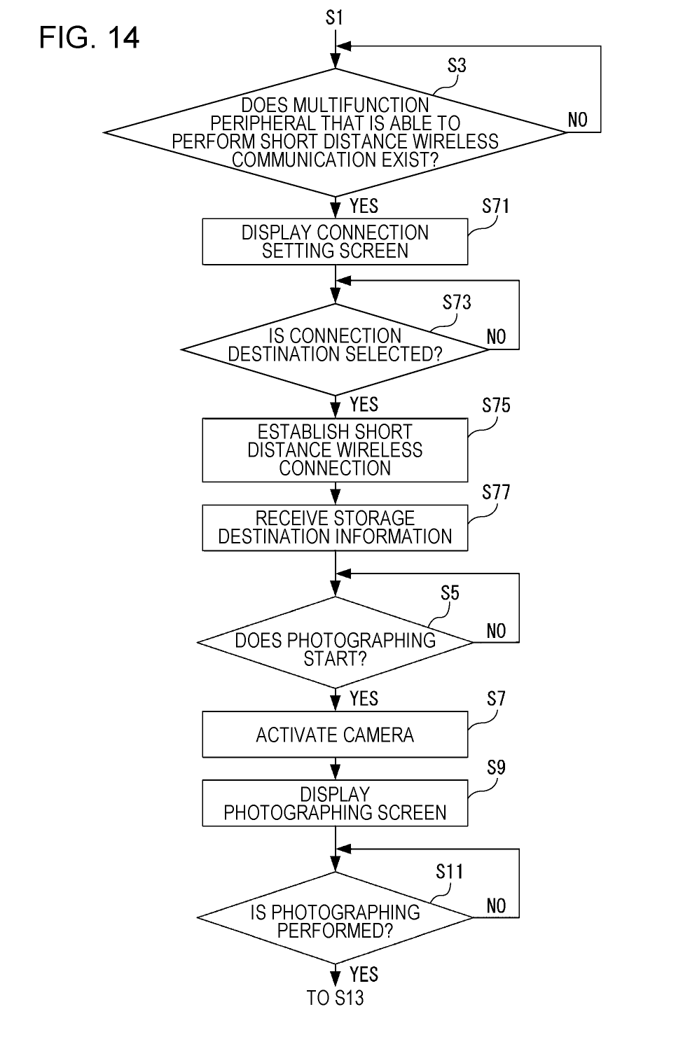

FIG. 14 is a flowchart illustrating an example of information processing of the CPU 202 of the user terminal 200 of the second embodiment. Hereinafter, the information processing in the second embodiment will be described by using the flowchart.

As illustrated in FIG. 14, after starting the information processing, in a case of “YES” at step S3, the CPU 202 displays the connection setting screen 180 on the display 212 at step S71, and determines, at step S73, whether or not a connection destination (image forming apparatus 14 which is to print the photographed image) is selected. Here, it is determined whether or not the selection icon 186 is touched on the connection setting screen 180. In a case of “NO” at step S73, that is, in a case where it is determined that the image forming apparatus 14 to be connected is not selected, the procedure returns to the same step S73. On the other hand, in a case of “YES” at step S73, that is, in a case where it is determined that the image forming apparatus 14 to be connected is selected, short distance wireless connection is established with the image forming apparatus 14 at step S75, storage destination information about a storage area for the image forming apparatus 14 is received, and the procedure proceeds to step S5.

Note that, since contents of processing up to step S3 and processing at step S5 and the following steps are the same as those of the first embodiment, description thereof will be omitted.

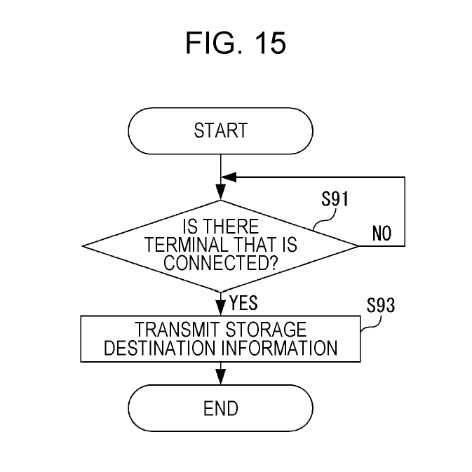

Next, connection processing that is executed by the CPU 142 of the image forming apparatus 14 will be described. FIG. 15 is a flowchart illustrating an example of the connection processing that is executed by the CPU 142 of the image forming apparatus 14 illustrated in FIG. 2. The connection processing and the aforementioned information processing which is executed by the CPU 142 of the image forming apparatus 14 are executed in parallel.

As illustrated in FIG. 15, when starting the connection processing, the CPU 142 of the image forming apparatus 14 determines, at step S91, whether or not there is a terminal with which short distance wireless connection is established. In a case of “NO” at step S91, that is, in a case where it is determined that there is no terminal with which the short distance wireless connection is established, the procedure returns to the same step S91.

On the other hand, in a case of “YES” at step S91, that is, in a case where it is determined that there is a terminal with which the short distance wireless connection is established, the storage destination information about the storage area for the image forming apparatus 14 is transmitted to the terminal at step S93, and the connection processing ends.

According to the second embodiment, the storage area for direct printing, which is in the server 12, includes a plurality of storage areas, each of the plurality of storage areas is allocated to a corresponding one of image forming apparatuses 14 adaptable to the direct printing application, and storage destination information about the storage area for the corresponding image forming apparatus 14 is transmitted from the image forming apparatus 14 to the user terminal 200. Thus, it is possible to print a photographed image, which is photographed by the user terminal 200, by an image forming apparatus 14 with a simple operation.

### Third Embodiment

Since the information processing system 10 of a third embodiment is the same as that of the first embodiment except that a code image in which storage destination information about a storage area for an image forming apparatus 14 is embedded is caused to be displayed on the display 152 of the image forming apparatus 14, a content different from that of the first embodiment will be described and duplicate description will be omitted.

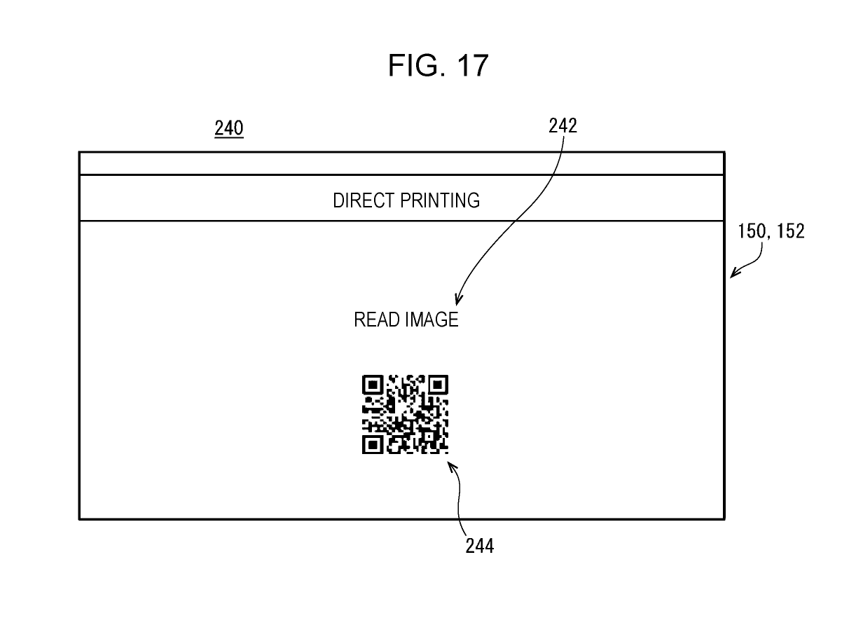

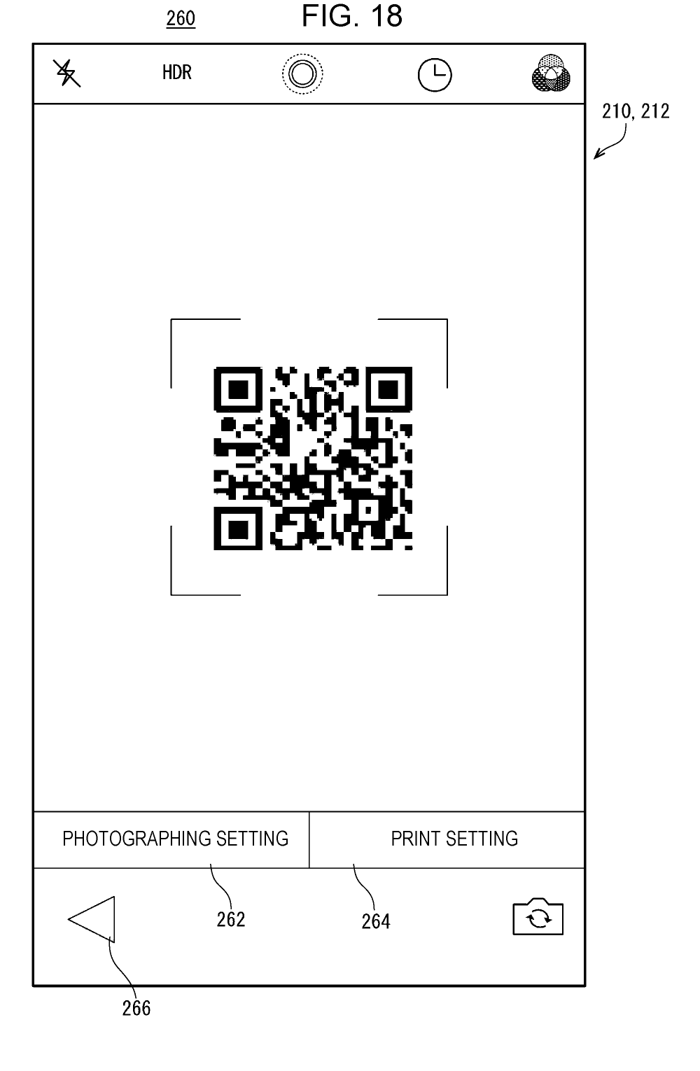

FIG. 16 is an explanatory diagram illustrating an example of the home screen 220 of the image forming apparatus 14 in the third embodiment. FIG. 17 is an explanatory diagram illustrating an example of a code display screen 240 of the image forming apparatus 14 in the third embodiment. FIG. 18 is an explanatory diagram illustrating an example of a code reading screen 260 of the user terminal 200 in the third embodiment.

When a power supply of the image forming apparatus 14 is turned on and the image forming apparatus 14 is in a standby state in which each of functions is able to be executed, the home screen 220 as illustrated in FIG. 16 is displayed on the display 152 of the image forming apparatus 14. In the home screen 220, an image of a software key (icon) for selecting each of jobs of copying, printing, facsimile, scanning, and the like and an image of a software key for displaying an operation screen (setting screen) in each job are displayed. Additionally, an image of an execution icon 222 for starting use of the direct printing application is displayed on the home screen 220.

When the execution icon 222 is touched, the code display screen 240 as illustrated in FIG. 17 is displayed on the display 152. In the code display screen 240, a code image 244 in which the storage destination information about the storage area for the image forming apparatus 14 is embedded and a message 242 for urging a user to read the code image 244 by the user terminal 200 are displayed. Note that, the code display screen 240 becomes non-displayed (returns to the home screen 220) when a predetermined time (for example, three to five minutes) elapses after the code display screen 240 is displayed on the display 152.

The code image 244 is, for example, a two-dimensional code. The two-dimensional code may be a matrix two-dimensional code such as a QR code (registered trademark), a micro QR code, a DataMATRIX code, a MaxiCODE, or a VeriCODE and may be a stacked two-dimensional code such as a PDF417 format, or a CODE49.

Additionally, in the user terminal 200 of the third embodiment, when the direct printing application is executed, the camera 214 is automatically activated and the code reading screen 260 as illustrated in FIG. 18 is displayed on the display 212.

In the code reading screen 260, a preview image corresponding to an image photographed by the camera 214 is displayed and a plurality of icons are also displayed. The plurality of icons include the photographing setting icon 262, the print setting icon 264, and the back icon 266.

Here, in the user terminal 200, whether or not the photographed image photographed by the camera 214 includes a code image (whether or not a code image is photographed) is determined. The code image is included in the photographed image when the user terminal 200 is moved to an appropriate position in a state in which the camera 214 is activated. In a case where the code image is included in the photographed image, the code image is extracted from the photographed image and the extracted code image is decoded.

After the code image is decoded, the user terminal 200 acquires the storage destination information which is embedded in the code image. When the user terminal 200 acquires the storage destination information, the photographing screen 120 is displayed on the display 212 of the user terminal 200. When the shutter icon 128 is touched on the photographing screen 120, the user terminal 200 transmits a photographed image to the server 12 via a public network. Note that, the storage destination information (information about the storage area for the image forming apparatus 14) which is decoded from the code image is associated with data of the photographed image transmitted from the user terminal 200 to the server 12.

Note that, in the third embodiment, processing ((1) of FIG. 4) in which whether or not the image forming apparatus 14 exists within the predetermined distance from the user terminal 200 is determined is omitted. This is because, in a case where the code image is included in the photographed image (the code image is photographed) in the code reading screen 260, it is estimated that the image forming apparatus 14 exists within the predetermined distance from the user terminal 200 (distance at which the code image is able to be photographed).

In the third embodiment, in order to realize the operation described above, a reading program for reading the code image, a decoding program for decoding the code image, and the like are included in the information processing program for the user terminal 200, which is stored in the RAM 204 of the user terminal 200. Additionally, a generation program for generating the code image in which the storage destination information is embedded and the like are included in the information processing program for the image forming apparatus 14, which is stored in the RAM 144 of the image forming apparatus 14.

Hereinafter, information processing in the third embodiment will be described with reference to flowcharts, the same reference sign is assigned to processing that is the same as the information processing described in the first embodiment, and description of a duplicated content will be omitted or briefly given.

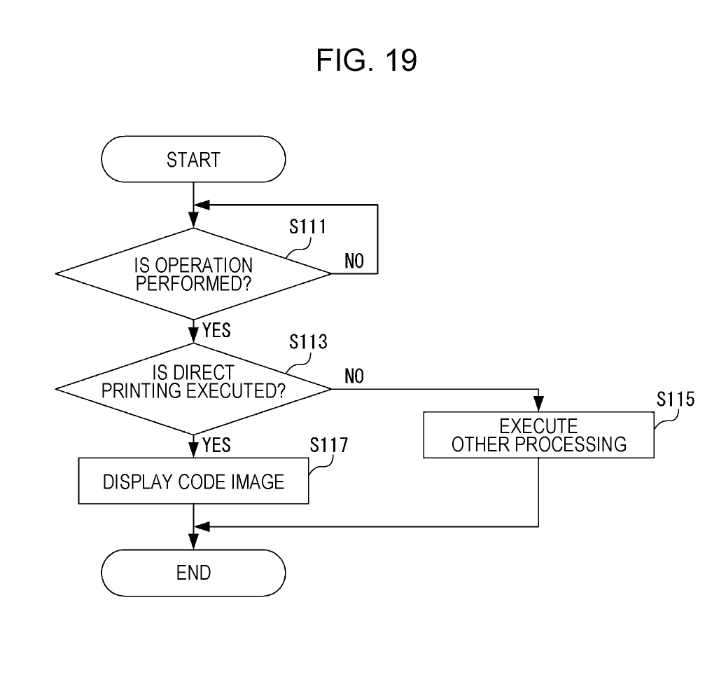

FIG. 19 is a flowchart illustrating an example of job selection processing that is executed by the CPU 142 of the image forming apparatus 14 illustrated in FIG. 2. The job selection processing is started when the home screen 220 is displayed on the display 152.

As illustrated in FIG. 19, when starting the job selection processing, the CPU 142 of the image forming apparatus 14 determines, at step S111, whether or not a user operation is performed. In a case of “NO” at step S111, that is, in a case where it is determined that a user operation is not performed, the procedure returns to the same step S111.

On the other hand, in a case of “YES” at step S111, that is, in a case where it is determined that a user operation is performed, whether or not direct printing is executed is determined at step S113. Here, whether or not the execution icon 222 is touched is determined. In a case of “NO” at step S113, that is, in a case where it is determined that the direct printing is not executed, other processing is executed at S115 and the job selection processing ends. The other processing that is executed at step S115 corresponds to processing by which each job is selected in accordance with an instruction of a user, processing by which various kinds of setting in each job are performed, or processing by which each job is started or stopped.

On the other hand, in a case of “YES” at step S113, that is, in a case where it is determined that the direct printing is executed, the code image 244 is displayed on the display 152 at step S117 and the job selection processing ends.

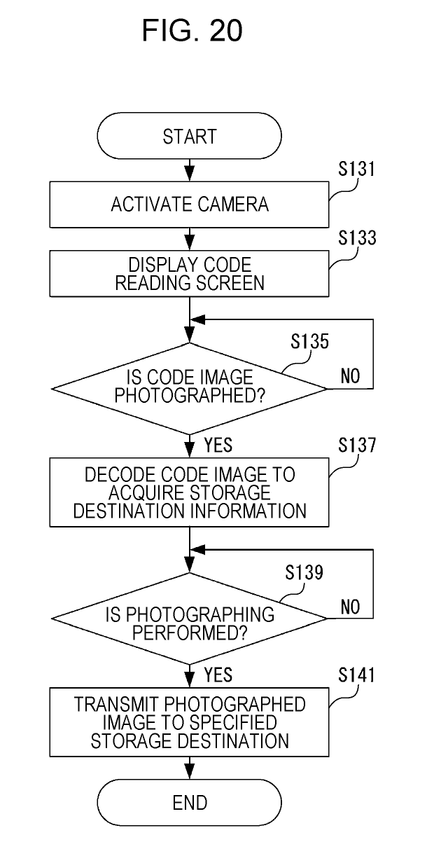

Next, information processing that is executed by the CPU 202 of the user terminal 200 will be described. FIG. 20 is a flowchart illustrating an example of the information processing of the CPU 202 of the user terminal 200 in the third embodiment. Hereinafter, the information processing in the third embodiment will be described by using the flowchart.

As illustrated in FIG. 20, when starting the information processing, the CPU 202 activates the camera 214 at step S131, displays the code reading screen 260 on the display 212 at step S133, and determines, at step S135, whether or not the code image is photographed. In a case of “NO” at step S135, that is, in a case where it is determined that the code image is not photographed, the procedure returns to the same step S135.

On the other hand, in a case of “YES” at step S135, that is, in a case where it is determined that the code image is photographed, the code image is decoded to acquire storage destination information at step S137, and whether or not photographing is performed is determined at step S139. In a case of “NO” at step S139, that is, in a case where photographing is not performed, the procedure returns to the same step S139. On the other hand, in a case of “YES” at step S139, that is, in a case where photographing is performed, the photographed image is transmitted to the server 12 in accordance with the storage destination information at step S141 and the information processing ends.

According to the third embodiment, the code image in which the storage destination information about the storage area for the image forming apparatus 14 is embedded is displayed on the display 152 of the image forming apparatus 14 and the user terminal 200 acquires the storage destination information from the code image, so that short distance wireless communication is not performed. Thus, since circuits for short distance communication are able to be omitted in the user terminal 200 and the image forming apparatus 14, it is possible to simplify configurations of the user terminal 200 and the image forming apparatus 14 and reduce the number of components, and therefore it is possible to reduce a manufacturing cost.

Note that, in the third embodiment, short distance wireless communication is not used to determine whether or not the image forming apparatus 14 exists within the predetermined distance from the user terminal 200. Thus, in the third embodiment, components for performing the short distance wireless communication, such as the short distance communication circuit 218 of the user terminal 200 and the short distance communication circuit 160 of the image forming apparatus 14, are able to be omitted.

Note that, in each of the embodiments described above, when a photographed image is transmitted from the server 12 to the image forming apparatus 14, data of the photographed image is deleted from the storage unit of the server 12, but there is no necessity to be limited thereto. For example, the data of the photographed image may be deleted when a predetermined period elapses after the photographed image is transmitted from the server 12 to the image forming apparatus 14, may be deleted in order from the oldest photographed image when a storage capacity of the storage unit of the server 12 reaches a prescribed amount or less, or a predetermined signal may be set to be transmitted from the image forming apparatus 14 to the server 12 when printing processing is normally executed and a photographed image used for the printing processing may be deleted when the server 12 receives the predetermined signal.

Additionally, in each of the embodiments described above, the storage area for direct printing is provided in the storage unit of the sever 12, but there is no necessity to be limited thereto. For example, the image forming apparatus 14 may include a storage unit constituted by a non-volatile memory and the storage area for direct printing may be provided in the storage unit of the image forming apparatus 14.

Furthermore, the screen, the specific configuration, and the like that are cited in each of the embodiments described above are an example and may be appropriately changed in accordance with an actual product. Moreover, a processing order of the steps of each of the flowcharts described in the aforementioned embodiments may be appropriately changed as long as the same effect is able to be obtained.

The present disclosure contains subject matter related to that disclosed in Japanese Priority Patent Application JP 2017-235662 filed in the Japan Patent Office on Dec. 8, 2017, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing system comprising: an information terminal; a storage apparatus; and an image forming apparatus, wherein
the information terminal includes
a first determination that determines whether or not the image forming apparatus exists within a predetermine distance,
a photographing unit that is activated in a case where the first determination unit determines that the image forming apparatus exists within the predetermined distance and to execute photographing by a user operation, and
a first transmission unit that transmits a photographed image photographed by the photographing unit to the storage apparatus via a public line,
the storage apparatus stores the photographed image transmitted from the information terminal, and
the image forming apparatus includes
an image forming unit that prints the photographed image stored in the storage apparatus.

2. The information processing system according to claim 1, wherein
the image forming apparatus further includes a second determination unit that determines whether or not the photographed image is stored in the storage apparatus, and
the image forming unit prints the photographed image in a case where the second determination unit determines that the photographed image is stored in the storage apparatus.

3. The information processing system according to claim 1, wherein the image forming unit prints the photographed image without depending on a user operation.

4. The information processing system according to claim 1, wherein
the storage apparatus includes a storage area that stores the photographed image,
the image forming apparatus further includes a transmission unit that transmits, to the information terminal, storage destination information that corresponds to the storage area,
the information terminal further includes an acquisition unit that acquires the storage destination information transmitted from the transmission unit,
the first transmission unit transmits the photographed image to the storage area that corresponds to the storage destination information acquired by the acquisition unit, and
the image forming unit prints the photographed image stored in the storage area that corresponds to the storage destination information.

5. The information processing system according to claim 4, wherein
the image forming apparatus and the information terminal perform short distance wireless communication with each other,
the transmission unit transmits the storage destination information by the short distance wireless communication, and
the acquisition unit receives the storage destination information by the short distance wireless communication.

6. The information processing system according to claim 4, wherein
the image forming apparatus further includes a display,
the transmission unit includes a display unit that causes the display to display a code image in which the storage destination information is embedded, and
the acquisition unit includes a decoding unit that, in a case where the photographing unit photographs the code image, decodes the photographed code image.

7. The information processing system according to claim 1, wherein
the storage apparatus includes a storage area that stores the photographed image,
the image forming apparatus and the information terminal perform short distance wireless communication with each other,
the information terminal further includes a second transmission unit that transmits, to the image forming apparatus, storage destination information that corresponds to the storage area by the short distance wireless communication,
the image forming apparatus further includes a reception unit that receives the storage destination information, which is transmitted from the second transmission unit, by the short distance wireless communication, and a second determination unit that determines whether or not the photographed image is stored in the storage area that corresponds to the storage destination information received by the reception unit,
the first transmission unit transmits the photographed image to the storage area that corresponds to the storage destination information, and
the image forming unit prints the photographed image in a case where the second determination unit determines that the photographed image is stored in the storage area.

8. An information terminal that is used in an information processing system including an image forming apparatus which, when an image is stored in a storage apparatus, executes printing processing by using the image, the information terminal comprising:
a first determination unit that determines whether or not the image forming apparatus exists within a predetermine distance,
a photographing unit that is activated in a case where the first determination unit determines that the image forming apparatus exists within the predetermined distance and to execute photographing by a user operation, and
a first transmission unit that transmits, as the image, a photographed image photographed by the photographing unit to the storage apparatus via a public line.

9. A non-transitory computer-readable storage medium storing a control program of an information terminal that is used in an information processing system including an image forming apparatus which, when an image is stored in a storage apparatus, executes printing processing by using the image, the control program causing a processor of the information terminal to function as:
a first determination unit that determines whether or not the image forming apparatus exists within a predetermine distance;
a photographing unit that is activated in a case where the first determination unit determines that the image forming apparatus exists within the predetermined distance and to execute photographing by a user operation; and
a first transmission unit that transmits, as the image, a photographed image photographed by the photographing unit to the storage apparatus via a public line.

10. A control method, executable by a processor of an information terminal that is used in an information processing system including an image forming apparatus which, when an image is stored in a storage apparatus, executes printing processing by using the image and that includes a photographing unit, the method comprising:
(a) determining whether or not the image forming apparatus exists within a predetermined distance;
(b) activating the photographing unit in a case where it is determined, at (a), that the image forming apparatus exists within the predetermined distance and executing photographing by a user operation; and
(c) transmitting, as the image, a photographed image that is photographed at (b) to the storage apparatus via a public line.
